(19) United States
(12) Patent Application Publication
(10) Pub. No.: US 2004/0239727 A1
(43) Pub. Date: Dec. 2, 2004

(54) Droplet ejecting device, electronic optical device, electronic device, manufacturing method for electronic optical device, and ejection control method for droplet ejecting device

(76) Inventor: Minoru Koyama, Matsumoto-shi (JP)

Correspondence Address: HARNESS, DICKEY & PIERCE, P.L.C., P.O. BOX 828, BLOOMFIELD HILLS, MI, 48303, US

(21) Appl. No.: 10/794,779

(22) Filed: Mar. 5, 2004

(30) Foreign Application Priority Data
Mar. 28, 2003 (JP) 2003-091951

(51) Int. Cl. B41J 2/14; B41J 2/16; B41J 2/05

(52) U.S. Cl. 347/47

(57) ABSTRACT

An inkjet device 100 has an inkjet head 114 for ejecting a liquid, in response to an ejection waveform, in the form of a droplet, the liquid being supplied from a liquid storage tank 150. Inkjet device also has a determining unit 174 for determining whether a measured viscosity of a liquid in liquid storage tank 150 is within a range of the liquid being ejectable, and a control unit 176 for, when a result of the determination by determining unit 174 is affirmative, applying an ejection waveform corresponding to a measured viscosity to an ejection of a droplet in inkjet head 114, while when a result of the determination by determining unit 174 is negative, suspending ejection of a droplet in inkjet head 114.

### RELATED APPLICATIONS

This application claims priority to Japanese Patent Application No. 2003-091951 which is hereby expressly incorporated by reference herein in its entirety.

### TECHNICAL FIELD

The present invention relates to a droplet ejecting device for ejecting a droplet, and also relates to an optical device, to an electronic device, to a manufacturing method for an electronic optical device, and to an ejection control method for a droplet ejecting device.

### BACKGROUND ART

In the prior art application of a droplet ejecting device, such as an ink jet device, for ejecting a droplet and making the droplet adhere to an object material, an inherent problem exists. The problem lies in the changing viscosity of a liquid to be ejected by the droplet ejecting device. The change in the viscosity of a liquid occurs due to an ambient temperature change, evaporation of a solvent of the liquid, and due to other reasons.

To solve the problem of the change in the viscosity of a liquid, a technique is known for controlling a temperature within an ink passage by means of PTC (Positive Temperature Coefficient) thermistor provided in close contact with a head base having the ink passage for ink to pass through. In the inkjet head, the PTC (Positive Temperature Coefficient) thermistor is used for controlling a heater to maintain its own temperature, and at the same time is used as a temperature sensor for detecting its own temperature, so as to control the ink passage at a fixed temperature, to thereby remedy the problem of the change in viscosity of the ink, which occurs over a period of time. By using the inkjet head, it is possible, to reduce the temperature rising time of a heater when reaching a preset temperature, to accurately control temperature, and to decrease the heater capacity.

There is another technique for controlling viscosity of an ink in a inkjet head, wherein by means of a first heater provided adjacent to ink nozzles and flow paths, the ink is caused to heat up such that the viscosity of the ink in the ink nozzles and the flow paths decreases to below a fixed value, and by means of a second heater adjacent to an ink reservoir, the ink reservoir is maintained within a temperature range of, at or above the melting point and also below the temperature of the ink nozzles and the flow paths.

Both techniques described above utilize temperature control technologies, for obtaining an estimated viscosity by heating a liquid. Although the existing technologies enable the viscosity of a liquid to be decreased by heating the liquid, a viscosity of a liquid in fact is influenced by factors, other than that of an increase in temperature, for e.g. due to factors such as an ambient temperature and humidity. A certain amount of time is required for the temperature of the ink to stabilize, as it is necessary to follow a sequential processing of: measuring temperature, detecting a fixed temperature, heating by a heater, changing the temperature of the ink, and obtaining condition change resulting from the sequential processing. Therefore, it is not possible to immediately and accurately lead the ink to a predetermined viscosity. In addition, the viscosity of some types of liquid may change quickly, and remarkably as temperature changes; and the viscosity of other liquids may change little, or very slowly. Therefore, it is difficult to determine whether a desired viscosity of a liquid has been obtained by causing a change in heating temperature.

### SUMMARY OF INVENTION

The present invention has been conceived in consideration of the above mentioned problems, and an object of the invention is to provide a droplet ejecting device for controlling ejection of a droplet in accordance with a change in the viscosity of a liquid, and to provide an electronic optical device, an electronic device, a manufacturing method for an electronic optical device, and an ejection control method for a droplet ejecting device.

(1) To solve the above-mentioned problems, a droplet ejecting device of the present invention comprises: a liquid storing means for storing a liquid; a droplet ejecting head for, by being applied an ejection waveform thereto, ejecting a liquid supplied from the liquid storing means in the form of a droplet; a measuring means for measuring a viscosity of a liquid stored in the liquid storing means; a determining means for determining whether the measured viscosity of a liquid is within a range of the liquid being ejectable; a memorizing means for memorizing one or more ejection waveforms corresponding to a viscosity being set within the range of the liquid being ejectable; and a control means for, if a result of the determination is affirmative, applying an ejection waveform to ejection in the droplet ejecting head, the ejection waveform being one of ejection waveforms memorized in the memorizing means and corresponding to a viscosity measured by the measuring means.

By this configuration, it is possible to apply an appropriate ejection waveform directly by referring to the viscosity of a liquid.

(2) In one preferred embodiment, the control means suspends ejection in the droplet ejecting head, if a result of the determination by the determining means is negative.

By this configuration, it is possible to suspend the ejection of a liquid having too high a viscosity, that the generation of a desired droplet may be affected.

(3) In another preferred embodiment, the droplet ejecting device further comprises a viscosity changing means for changing the viscosity of a liquid in the liquid storing means, wherein the control means suspends the ejection of a liquid in the droplet ejecting head, as well as changes, by the viscosity changing means, the viscosity of the liquid in the liquid storing means, and causes the viscosity to come into the range the liquid being ejectable, if a result of the determination is negative.

By this configuration, it is possible to replace an ejection waveform to be applied for ejection of a droplet in response to a change in the viscosity of a liquid. It is also possible to suspend the driving of ejection of a liquid having a viscosity, which is outside the predetermined range of viscosity, as well as change the viscosity of the liquid as necessary during suspension, to cause the liquid to become appropriately viscous for ejection.

(4) Further, the present invention provides a droplet ejecting device comprising: a liquid storing means for storing a liquid; a droplet ejecting head for ejecting a liquid supplied from the liquid storing means in the form of a droplet; a measuring means for measuring a viscosity of a liquid stored in the liquid storing means; a determining means for determining whether the measured viscosity of a liquid is within the range of a liquid being ejectable; a viscosity changing means for changing a viscosity of a liquid in the liquid storing means; and a control means for, if a result of the determination is negative, suspending ejection in the droplet ejecting head as well as changing, by the viscosity changing means, the viscosity of the liquid in the liquid storing means and causing the viscosity to come into the range of the liquid being ejectable.

Thus, in one preferred embodiment, the droplet ejecting device may suspend ejection of a liquid having a viscosity, which is outside the predetermined range, as well as change the viscosity of the liquid as necessary during the suspension and cause the liquid to become appropriately viscous for ejection.

(5) Further, the measuring means of the droplet ejecting device of the present invention according to any one of above (1) to (4) comprises, an electrode unit immersed in a liquid in the liquid storing means, an oscillation frequency measuring unit for measuring an oscillation frequency of the electrode unit, and a viscosity measuring unit for measuring a viscosity on the basis of the ratio between the measured oscillation frequency and a natural oscillation frequency of the electrode unit.

(6) Further, the present invention provides a droplet ejecting device according to any one of above (1) to (5), wherein a use of the droplet ejecting device is to eject one of a print liquid for printing, a conductive liquid for forming a conductor pattern, a liquid crystal material or a liquid material for forming a color filter in a display device, a liquid of EL (electroluminescence) material for forming an EL layer, a resist liquid for forming a resist layer, a biochemical liquid containing biochemical material, and a liquid of light-transparent material for forming a micro lens array.

### BRIEF DESCRIPTION OF THE DRAWINGS

FIG. 1 is a diagram showing a configuration of an inkjet device according to a first embodiment of the present invention.

FIG. 2 is a diagram showing an example of viscosity setting table stored in a viscosity measurement device of the inkjet device.

FIG. 3 is a diagram showing an AND circuit provided in a drive control circuit of the inkjet device.

FIG. 4 is a flowchart showing an operation of the inkjet device.

FIG. 5 is a timing chart showing an example of an operation of the inkjet device.

FIG. 6 is a timing chart showing an example of an operation of the inkjet device.

FIG. 7 is a diagram showing a configuration of an inkjet device according to a second embodiment of the present invention.

FIG. 8 is a flowchart showing an operation of the inkjet device.

FIG. 9 is a timing chart showing an example of an operation of the inkjet device.

FIG. 10 is a flowchart showing an operation according to a modification of the inkjet device.

FIG. 11 is a diagram showing an electronic optical device manufactured by using an inkjet device according to the present invention.

FIG. 12 is a diagram showing an electronic device having an electronic optical device mounted thereto, the electronic optical device manufactured by using an inkjet device according to the present invention.

### DETAILED DESCRIPTION OF PREFERRED EMBODIMENTS

Hereinafter, embodiments of the present invention will be described with reference to the attached drawings.

<First Embodiment>

Configuration of Inkjet Device 100:

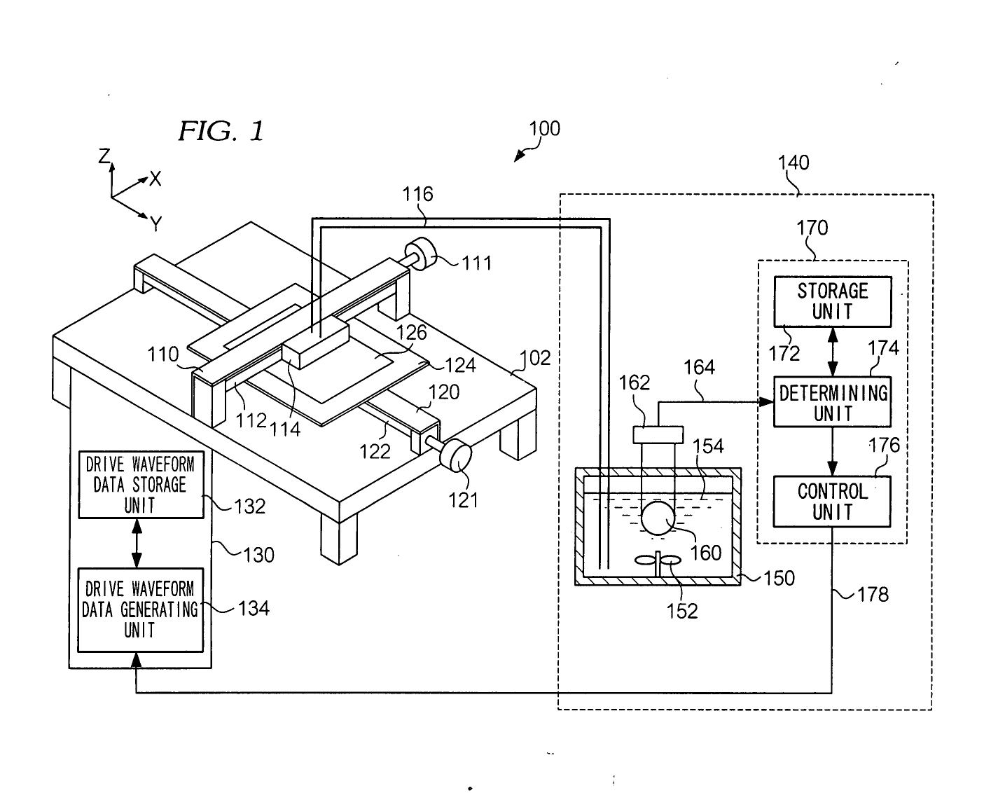

First, with reference to FIG. 1, a configuration of an inkjet device 100 according to the present invention shall be described.

FIG. 1 is a diagram showing a functional configuration of an example of inkjet device 100 according to the present invention. The inkjet device 100 is a device for making a droplet containing, for example, silver microscopic particles and C₁₄H₃₀ (tetradecane), adhere to a substrate 126 at a certain position, and forms a desired conductive film pattern on substrate 126.

Inkjet device 100 is provided with, on a base 102, an X-direction driving device 110 as a means for carrying a head unit, and a Y-direction driving device 120 as a means for carrying a substrate. Underneath base 102 is provided a head driving control circuit 130. It is to be noted that in the figure, X-direction, Y-direction and Z-direction are orthogonal to one another.

X-direction driving device 110 comprises an X-direction driving motor 111, an X-direction driving shaft 112 and an inkjet head 114. X-direction driving motor 111, on receiving from an X-direction driving circuit (not shown) an X-scan driving signal at predetermined intervals (for example, 10 ms), for causing inkjet head 114 to perform scanning, carries inkjet head 114 along X-direction driving shaft 112. Similarly, Y-direction driving device 120 comprises a Y-direction driving motor 121, a Y-direction driving shaft 122 and a substrate supporting board 124. Y-direction driving motor 121, on receiving from a Y-direction driving circuit (not shown), a Y-scan driving signal for causing substrate supporting board 124 to perform scanning, carries substrate supporting board 124 along Y-direction driving shaft 122. A substrate 126, an object to which a droplet from inkjet head is to be ejected, is fixed to substrate supporting board 124 by a vacuum suction means (not shown), and is carried by substrate supporting board 124 as it moves.

Head driving control circuit 130, synchronized with cessation of scanning by X-direction driving device 110 or Y-direction driving device 120, generates an ejection starting signal PTS1 (Print Timing Signal 1) indicating start of driving ejection of a droplet. Head driving control circuit 130, in response to the ejection starting signal PTS1, reads out ejection data of a droplet to be ejected from an ejecting nozzle of inkjet head 114, and supplies the same to inkjet head 114. A drive waveform data generating unit 134 of head driving control circuit 130 reads out drive waveform data from a drive waveform data storage unit 132 in which the drive waveform data corresponding to the ejection data is stored, and generates a drive waveform signal COM having a waveform indicated by the drive waveform data. Then, the driving waveform data generating unit 134, synchronized with the ejection data being supplied to inkjet head 114, supplies the generated drive waveform signal COM to inkjet head 114. Drive waveform data generating unit 134 also receives a replacement indication signal indicative of replacement of drive waveform data, which is the signal supplied by a viscosity measuring device 140 (described later in detail), and changes drive waveform data for a drive waveform signal COM to be applied to inkjet head 114.

On the basis of the provided ejection data and drive waveform signal COM, a desired ejection drive voltage is applied to inkjet head 114.

In the meantime, inkjet head 114 is supplied with a liquid which is transmitted from a liquid storage tank 150 of viscosity measurement device 140 through a feed pipe 116. Inkjet head 114, in response to an application of the desired ejection drive voltage, compresses and expands an internal chamber (not shown), in which the liquid is filled, to thereby eject a droplet of a desired volume from a nozzle.

In inkjet device 100 is also provided a viscosity measurement device 140 for measuring the viscosity of a liquid by using a crystal oscillator.

Viscosity measurement device 140 provides a measurement circuit 162 in which is provided a crystal oscillator. The crystal oscillator is connected to an electrode unit 160 immersed in a liquid 154. Measurement circuit 162 measures an oscillation frequency of the crystal oscillator at electrode unit 160, the oscillation frequency depending on the viscosity of liquid 154 in which electrode unit 160 is immersed. Measurement circuit 162 calculates the ratio between the measured oscillation frequency and a natural oscillation frequency of the crystal oscillator and measures, in accordance with a function system based on the ratio, a viscosity of the liquid filled in liquid storage tank 150. It is to be noted that in liquid storage tank 150 is provided an agitation unit 152 for agitating a liquid.

Data indicating the viscosity measured by measurement circuit 162 is transmitted via a connecting wire 164 to a viscosity determining device 170 for determining viscosity. A determining unit 174 of viscosity determining device 170 determines on the basis of the received data whether the measured viscosity is within a viscosity setting range, preset in a storage unit 172.

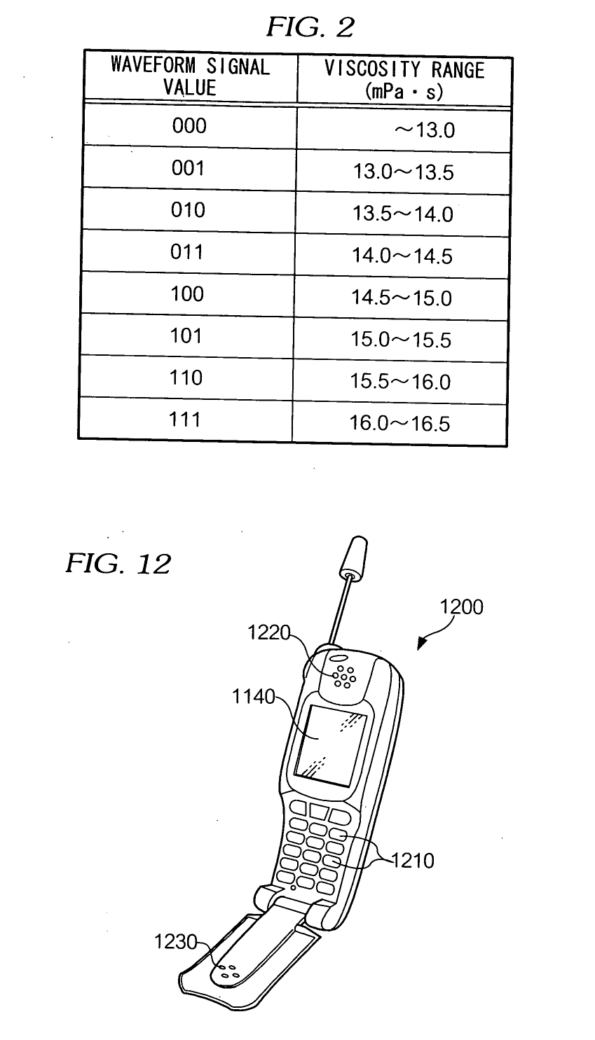

Now, with reference to FIG. 2, an explanation will be given of an example of the viscosity setting table indicative of a viscosity setting, stored in storage unit 172.

In storage unit 172, the table shows eight viscosity settings, each setting corresponding to a particular level of viscosity. For e.g., in the row direction of a viscosity setting table corresponding to “waveform signal value: 000”, a “viscosity range (mPa·s): to 13.0” is stored. The “viscosity range (mPa·s): to 13.0” indicates that a viscosity of a liquid is below 13.0 mPa·s. Similarly, in another viscosity setting, corresponding to “waveform signal value: 001”, “viscosity range (mPa·s): 13.0 to 13.5” is stored. The “viscosity range (mPa·s): 13.0 to 13.5” indicates that a viscosity of a liquid is within a range starting from 13.0 mPa·s but below 13.5 mPa·s. Similarly, in yet another viscosity setting, corresponding to “waveform signal value: 111”, “viscosity range (mPa·s): 16.0 to 16.5” is stored. The “viscosity range (mPa·s): 16.0 to 16.5” indicates that a viscosity of a liquid is within a range starting from 16.0 mPa·s but below 16.5 mPa·s.

A control unit 176 of viscosity measurement device 140, if it is determined by determining unit 174 that the measured viscosity is within the range of viscosity settings, i.e., below 16.5 mPa·s, transmits to head drive control circuit 130 via a connection wire 178, an indicating signal READY indicative of “ON” for validating an ejection start signal PTS1 transmitted upon completion of scanning movement of X-direction drive device 110 or Y-direction drive device 120. Control unit 176 also transmits a waveform signal value corresponding to one of the viscosity settings in the viscosity setting table shown in FIG. 2, to head drive control circuit 130 via connection wire 178. On the other hand, if it is determined by determining unit 174 that the measured viscosity is not within the range of viscosity settings (i.e., below 16.5 mPa·s), control unit 176 transmits to head drive control circuit 130 via connection wire 178 an indicating signal READY indicative of “OFF” for invalidating an ejection start signal PTS1 transmitted upon completion of scanning movement by X-direction drive device 110 or Y-direction drive device 120.

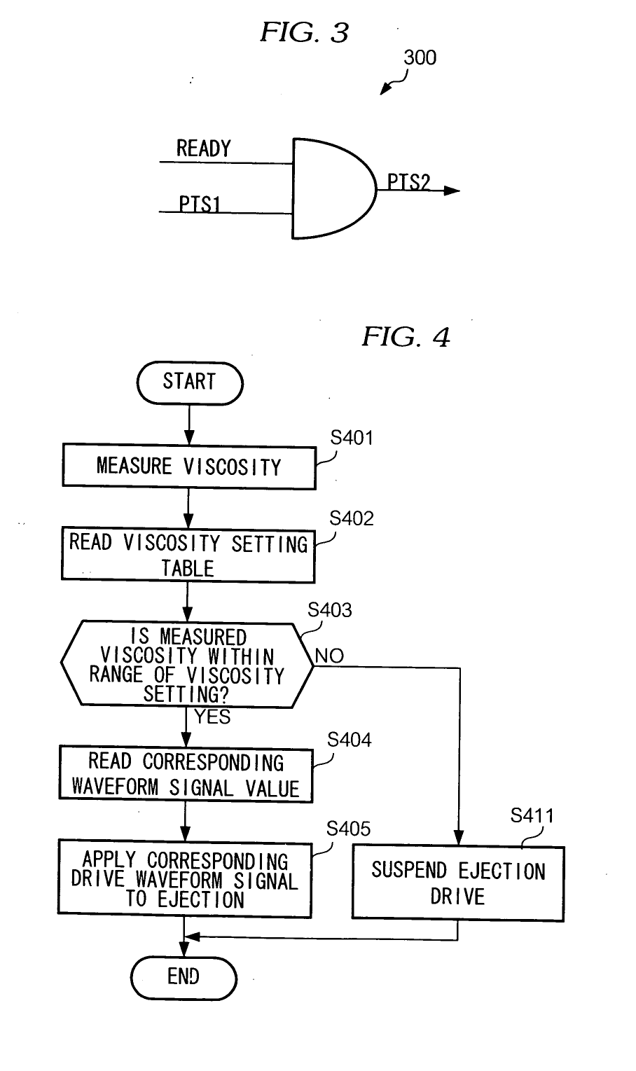

FIG. 3 shows a circuit diagram of head drive control circuit 130, for, in accordance with an indicating signal READY indicative of “ON” or “OF” transmitted from viscosity measurement device 140, validating or invalidating an ejection start signal PTS1 directive of start of driving ejection.

The AND circuit 300 transmits, when an ejection start signal PTS1 is supplied thereto and also when an indicating signal READY indicates “ON”, an ejection start signal PTS2 corresponding to the ejection start signal PTS1. Conversely, in the condition where an ejection start signal PTS1 is being supplied, while an indicating signal READY indicates “OFF”, AND circuit 300 does not transmit an ejection start signal PTS2.

Operation of Inkjet Device 100:

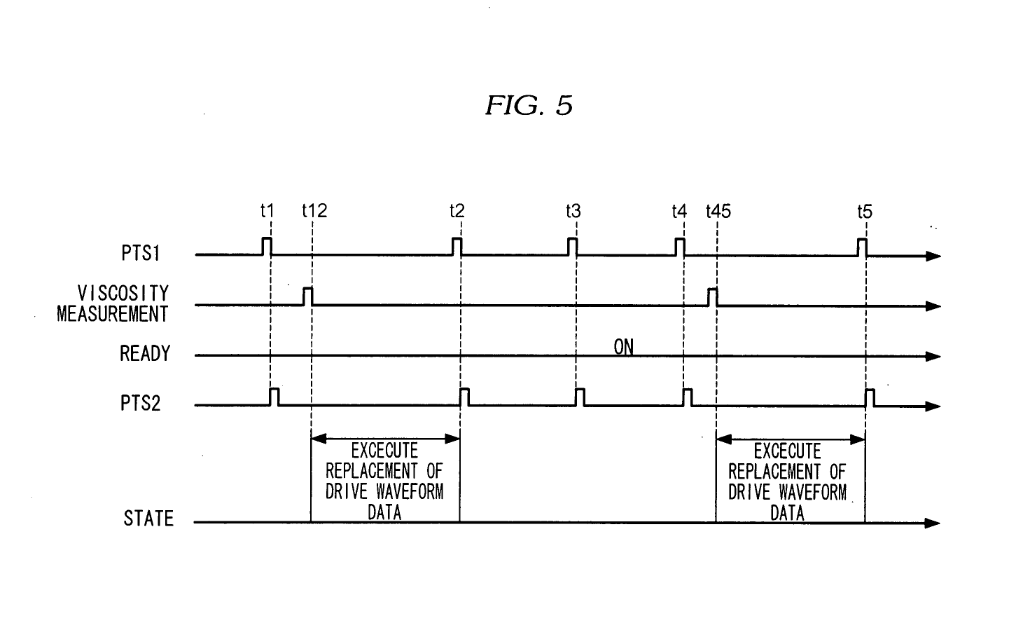

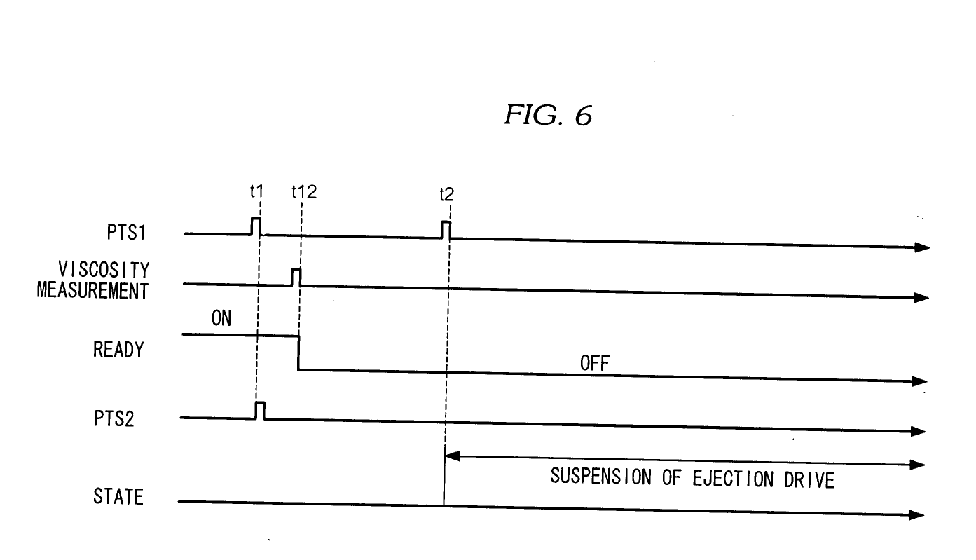

Next, an explanation of the operation and the effects of an inkjet device 100, will be given with reference to a flowchart of FIG. 4, and timing charts of FIGS. 5 and 6 conceptually showing associated timing and operation.

Viscosity measurement device 140, via electrode unit 160, measures viscosity of liquid 154 in liquid storage tank 150 at predetermined intervals (5 seconds, for example) (step S401). For example, it is assumed that the viscosity of a liquid with an initial viscosity of 13.3 mPa·s was measured to be 14.1 mPa·s (hereinafter, referred to as measured viscosity 14.1 mPa·s) in step S401.

It is to be noted that the time when measured, the measured viscosity 14.1 mPa·s corresponds to time t12 shown in a timing chart of FIG. 5.

Determining unit 174 of viscosity measurement device 140 reads out viscosity setting table (FIG. 2) stored in storage unit 172 (step S402), and determines whether the measured viscosity 14.1 mPa·s is within the range of viscosity settings, i.e., below 16.5 mPa·s (step S403).

In this case, determining section 174 of viscosity measurement device 140 determines that measured viscosity 14.1 mPa·s is within the range of viscosity settings (step S403; Yes). Determining section 174 further selects and reads out a waveform signal value “011” corresponding to measured viscosity 14.1 mPa·s (step S404).

Control unit 176 of viscosity measurement device 140 transmits to head drive control circuit 130 via a connecting wire 178 a replacement indicating signal for replacing a drive waveform signal COM corresponding to a waveform signal value “001” set for the initial viscosity 13.3 mPa·s by a drive waveform signal COM corresponding to the read out waveform signal value “011”. When head drive control circuit 130 receives the replacement indicating signal, drive waveform data generating unit 134 of head drive control circuit 130 reads out drive waveform data corresponding to the waveform signal value “011” from drive waveform data storage unit 131 in which data of the drive waveform signal COM is stored, and generates a drive waveform signal COM (step S405). Drive waveform data generating unit 131 of head drive control circuit 130 then supplies the drive waveform signal COM corresponding to the read out waveform signal value “011”, in place of a drive waveform signal COM corresponding to the waveform signal value “001”.

Thereafter, inkjet device 100, by using viscosity measurement device 140, performs at predetermined time intervals, the same operation as that of the above described steps S401 through S405, for example, for a period from time t45 at which a next viscosity measurement is performed to time t5 at which a next ejection starting signal PTS1 is generated as shown in the timing chart of FIG. 5.

Now, an explanation will be given of a case where a viscosity of 30.0 mPa·s is measured for liquid 154 of initial viscosity of 13.3 mPa·s in the step S401 of FIG. 4. The point of time when the viscosity measurement is performed corresponds to time t12 in FIG. 6.

Determining unit 174 of viscosity measurement device 140 reads out from storage unit 172 a viscosity setting table (FIG. 2) stored in storage unit 172 (step S402) and determines whether the measured viscosity 30.0 mPa·s is within the range of viscosity setting (below 16.5 mPa·s) indicated by the table (step S 403). In this case, determining unit 174 determines that the measured viscosity 30.0 mPa·s is not within the range of viscosity settings (step S403; No).

Then, as shown in FIG. 6, in synchronization with a point of time t12 at which step S 403 is performed, control unit 176 of viscosity measurement device 140 transmits via connection wire 178 an indicating signal READY, indicative of “OFF” for invalidating an ejection start signal PTS1. The indicating signal READY is applied to AND circuit 300 shown in FIG. 3. Since at a point of time t2 shown in FIG. 6, the signal READY indicates “OFF”, a projected point does not appear for ejection start signal PTS2 at the time t2. Accordingly, ejection drive is suspended (step S411). At this time, driving of X-direction driving device 110 or Y-direction driving device is also suspended and is not resumed until the ejection drive is resumed.

In the above example, an explanation is given of a case where the measured viscosity is 30.0 mPa·s which is higher than the higher limit of the range of viscosity settings. However, there may be a case where ejection drive should be suspended if a measured viscosity is on the contrary as low as, for example, 5.0 mPa·s. In this case, in the record corresponding to a waveform signal value “000” in FIG. 2, a viscosity range of “12.5 to 13.0” may be set. Thus, by setting a lower limit in the range of viscosity settings, it is also possible to suspend ejection drive when the measured viscosity is too low for ejection.

As in the foregoing, inkjet device 100 according to the present embodiment replaces, in response to a change in the viscosity of a liquid, drive waveform signals to be applied in correspondence with ejection data, and also suspends ejection drive in regard to a liquid having a high viscosity exceeding a predetermined viscosity range. Accordingly, it is possible to apply an appropriate drive waveform signal directly, according to the viscosity of a liquid; and to suspend driving ejection of a liquid with high or low viscosity which may affect the generation of a desired droplet.

<Second Embodiment>

Configuration of an inkjet device according to the second embodiment:

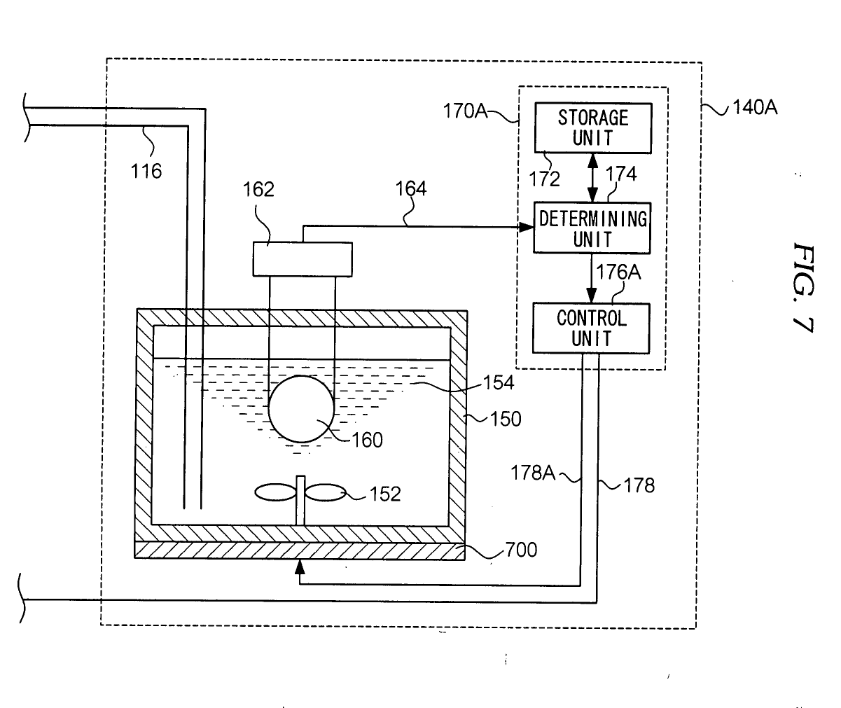

Next, an explanation will be given of an inkjet device according to the present second embodiment. It is to be noted that the inkjet device of the present embodiment differs particularly in a configuration of viscosity measurement device 140 shown in FIG. 1. Hereafter, with reference to FIG. 7, an explanation will be given of a viscosity measurement device 140A used in the present embodiment. It is to be noted that in order to avoid a repetition of the same explanation, the same reference numerals are used for likewise components of the configuration with those of inkjet device 100 of FIG. 1. The use of the same reference numerals will also be employed in the other embodiments below.

Viscosity measurement device 140A provides a measurement circuit 162 in which is provided a crystal oscillator. The crystal oscillator is connected to an electrode unit 160 immersed in liquid 154. Measurement circuit 162 measures an oscillation frequency of the crystal oscillator at electrode unit 160, the oscillation frequency depending on the viscosity of liquid 154 in which electrode unit 160 is immersed. Measurement circuit 162 calculates the ratio between the measured oscillation frequency and a natural oscillation frequency of the crystal oscillator, and based on the ratio, measures a viscosity of the liquid filled in a liquid storage tank 150. At the bottom surface of liquid storage tank 150 is provided a temperature changing unit 700 for changing the viscosity of a liquid, by heating with a high temperature and high pressure valve or by cooling with a cooling valve. A control unit 176A of a viscosity determining device 170A has the same function as that of control unit 176 shown in FIG. 1, and also supplies voltage for driving temperature changing unit 700 via a connecting wire 178A, if it is not confirmed by determining unit 174 that a measured viscosity is within a viscosity setting (below 16.5 mPa·s).

Operation of an inkjet device according to the second embodiment:

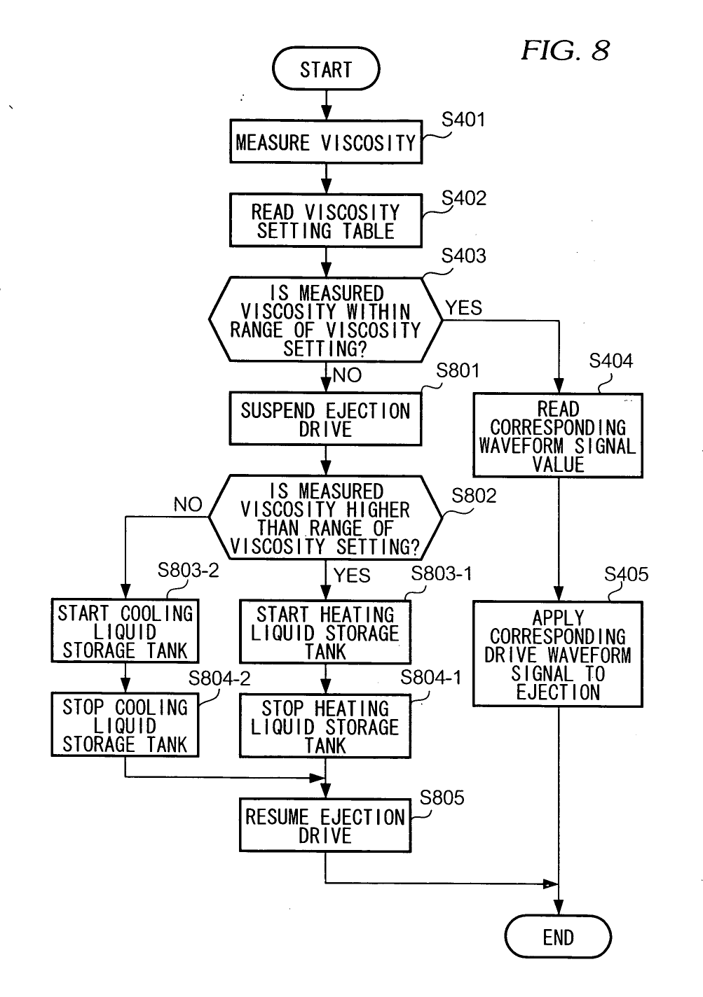

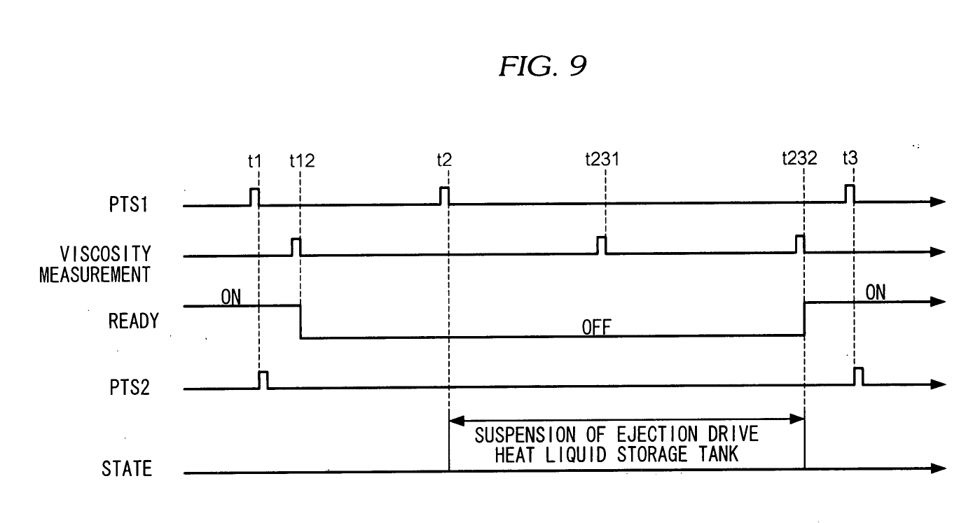

Next, an explanation of the operation and effects of an inkjet device of the present embodiment, will be given, with reference to a flowchart of FIG. 8, and a timing chart of FIG. 9 conceptually showing associated timing and operation. A detailed explanation with regard to steps S401 through S405 which steps are the same as those in FIG. 4, is omitted. It is assumed in the following description, that a viscosity range starting from 10.0 mPa·s to below 16.5 mPa·s is set for a waveform signal value “000” in a viscosity setting table of the present embodiment corresponding to the aforementioned viscosity setting table of FIG. 2.

The measurement taken by viscosity measurement device 140A, using electrode unit 160, of liquid 154 whose initial viscosity is 13.3 mPa·s, shows that at present the viscosity of liquid 154 is 32.0 mPa·s (step S401).

The point of time at which the measurement of the viscosity is taken, corresponds to time t12 of timing chart shown in FIG. 9.

Determining unit 174 of viscosity measurement device 140A reads out viscosity setting table stored in storage unit 172 (step S402) and checks whether the measured viscosity 32.0 mPa·s is within the range of visocosity settings, i.e., starting from 10.0 mPa·s to below 16.5 mPa·s (step S403).

In this case, determining unit 174 of viscosity measurement device 140A confirms that the measured viscosity of 32.0 mPa·s is not within the range of viscosity settings.

Next, the same operation as that of step S411 in FIG. 4 is performed (step S801).

In the meantime, when it is confirmed that the viscosity of 32.0 mPa·s measured in step S401 exceeds the upper limit of the range of viscosity settings (step S802; Yes), control unit 176A of viscosity measurement device 140A supplies a voltage to temperature change unit 700 via a connection wire 178A in order to heat liquid storage tank 150 (step S803-1).

The time at which supply of the voltage is ceased corresponds to the time at which it is determined, based on another viscosity measurement thereafter performed by viscosity measurement device 140A, that a measured viscosity is within the range of viscosity settings. If it is determined that the measured viscosity is within the range of viscosity settings, control unit 176A of viscosity measurement device 140A stops supplying a voltage to temperature change unit 700 (step S804-1).

It is to be noted that the period during which the steps S801 to S804 are performed, corresponds to a period from time t2 to time t232: t2 of timing chart in FIG. 9 indicating the time at which the suspension of ejection drive is confirmed by AND circuit (FIG. 3) on the basis of ejection start signal PTS1 and an indicating signal READY indicative of “OFF”; and t232 indicating the time at which it is confirmed on the basis of another measurement, that a measured viscosity is within the range of viscosity setting.

Next, control unit 176A of viscosity measurement device 140A supplies to head drive control circuit 130, via connection wire 178, an indicating signal READY indicative of “ON”, for validating an ejection start signal PTS1. As a result, the ejection drive is resumed (step S805).

The time at which step S805 is performed, corresponds to, time t3 of timing chart FIG. 9, when ejection start signal PTS2 is received. On the other hand, if it is confirmed in step S802, that the measured viscosity is 5.0 mPa·s, for example, control unit 176A of viscosity measurement device 140A supplies a voltage to temperature change unit 700 via a connection wire 178A, in order to cool liquid storage tank 150 (step S803-2). When it is confirmed, on the basis of another viscosity measurement performed thereafter by viscosity measurement device 140A, that the measured viscosity is within the range of viscosity settings, control unit 176A of viscosity measurement device 140A stops supplying voltage to temperature change unit 700 (step S804-2).

As in the foregoing, by using an inkjet device according to the present embodiment, it is possible to replace a drive waveform signal to be applied for ejection of a droplet in response to a change in the viscosity of a liquid. It is also possible to suspend driving ejection of a liquid having a viscosity outside a predetermined range, and change the viscosity during suspension so as to cause the viscosity to change into that appropriate for ejection. Accordingly, it is possible to apply a drive waveform signal, on the basis of the actual viscosity of a liquid, and suspend the ejection drive of a liquid having a viscosity too high or too low that may affect the generation of the desired droplet.

Modification of an inkjet device of the second embodiment:

It is possible to apply the use of an inkjet device described above with reference to FIGS. 7 to 9 to the following modification.

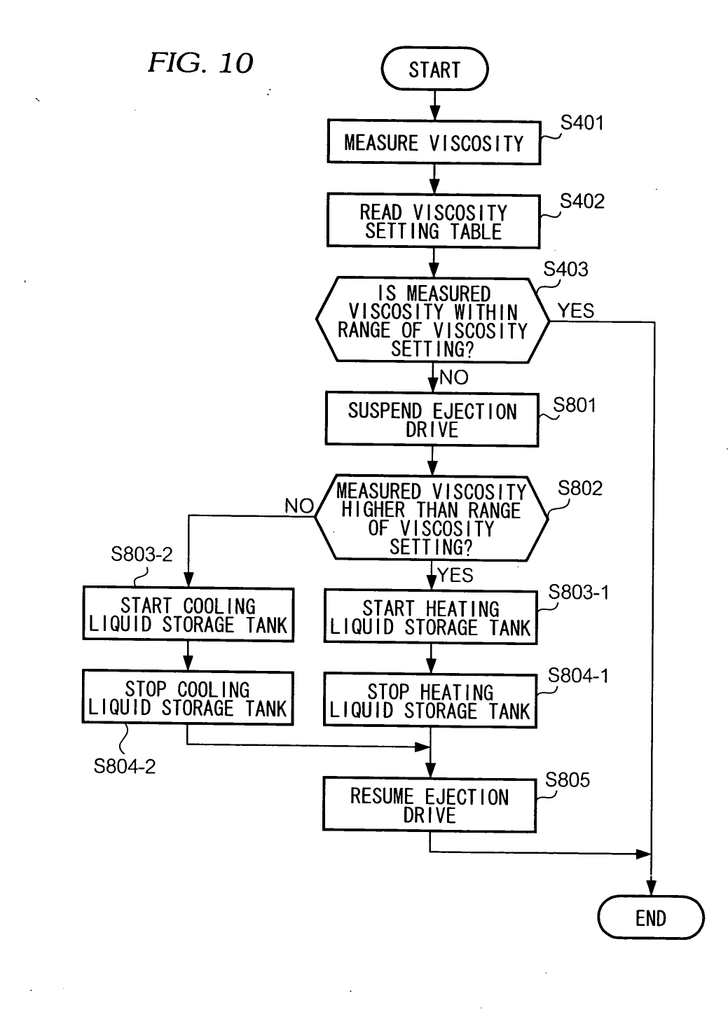

An inkjet device of the present modification differs partially from the inkjet device described in the second embodiment. In the present modification, the inkjet device does not carry out the operations corresponding to steps S404 and S405 described above, and the operation of the aforementioned step S403, shown in flowchart of FIG. 8, is also partially different. And, a configuration of the present modification (see FIG. 7), differs from that of the above embodiment in the data contained in viscosity setting table stored in storage unit 172, and in the determining process of determining unit 174. Hereafter, an explanation will be given of the modification with reference to FIGS. 7 and 10.

In a storage unit of an inkjet device according to the present modification, the storage unit corresponding to storage unit 172, a range of viscosity for a liquid to be ejected is stored, for example, as “viscosity range (mPa·s): 13.0 to 15.0”.

A determining unit of the present example, which corresponds to determining unit 174, determines whether a measured viscosity is within the required range of viscosity.

If it is determined by the determining unit that the measured viscosity is within the required range of viscosity, control unit 176A performs subsequent ejection drive in accordance with a drive waveform signal COM, which is set in advance. On the other hand, if it is determined that the measured viscosity is not within the required range, control unit 176A performs steps S801 to S805 shown in FIG. 10.

Thus, according to an inkjet device of the present embodiment, it is possible to suspend ejection drive of a liquid having a viscosity outside a predetermined range, and during the suspension, it is possible to heat or cool a liquid storage tank as appropriate, to cause the viscosity to change into that which is appropriate for ejection. Accordingly, it is possible to suspend the ejection drive of a liquid with viscosity that is too high/low and may consequently affect the generation of a desired droplet.

Various examples:

Inkjet devices described above in the first and second embodiments are merely examples, and the present invention is not limited to the foregoing embodiments, but various modifications and improvements may be made thereto, without departing from the scope and spirit of the invention.

In the above described second embodiment, as shown in FIG. 9, the period required for heating the liquid depends on whether the viscosity measured by viscosity measurement device 140A changes and comes into predetermined range of viscosity. However, the time period and temperature required for heating a liquid, may be preset on the basis of a correlation graph, by taking into account, the type of liquid and the differences in changes of viscosity of liquids. In this case, a viscosity change table on the basis of the correlation graph is stored in control unit 176A for supplying voltage to temperature change unit 700. Control unit 176A, in accordance with the viscosity change table, supplies a voltage level corresponding to the temperature for heating of the liquid, for a corresponding time. This may also be applied to a modification shown in the second embodiment.

Further, it is assumed in an inkjet device according to the first embodiment, that viscosity measurement is performed at predetermined intervals (5 seconds, for example). However, by presetting a time of starting measurement, viscosity measurement may be started on the basis of the preset time. Alternatively, the start of viscosity measurement may be synchronized with supplying an ejection start signal PTS1. This may also be applied to the second embodiment and to its modification.

Further, an inkjet device in the first embodiment determines suspension of ejection by using AND circuit 300 with an ejection start signal PTS1 and an indicating signal READY. However, suspension of ejection may be determined on the basis of the presence of a driving voltage applied to either X-direction drive device 110 or Y-direction drive device 120.

In the aforementioned first and second embodiments and their various applications, an explanation is given of each of the inkjet devices as a device for making a droplet containing conductive materials adhere to a certain position on substrate 126. However, in addition, the droplet ejecting device may be used for printing paper with a coloring liquid, manufacturing an EL (electroluminescence) element, resist forming, forming a color filter or enclosing a liquid crystal material on a glass substrate of a liquid crystal display device, manufacturing a micro lens array, and ejecting a liquid for measuring bio substance.

(1) An inkjet device of the present invention may be, for example, a device for forming a layer of an organic EL element, such as a hole transporting emissive layer and an electron transport layer, or a device for forming a fluorescent emitting layer of an inorganic EL element. Furthermore, an inkjet device of the present invention may be any of: a device for applying a resist in lithography process for forming a certain conductive film pattern; a device for applying light-transmissible material to a master disk comprising a plurality of projecting parts in the manufacturing process of a micro lens array; a device for ejecting a catalyst for determining or measuring the type or mass of bio-substance such as DNA (deoxyribonucleic acid) and so on infused in a vessel such as a test tube; a device for ejecting the bio-substance per se on a vessel such as a petri-dish; and the like.

<Electronic Optical Device and Electronic Device>

Description will now be given of an electronic optical device having a color filter formed by using a droplet ejecting device in the above described two embodiments or in the other various applications, and of an electronic device employing the electronic optical device as its display unit.

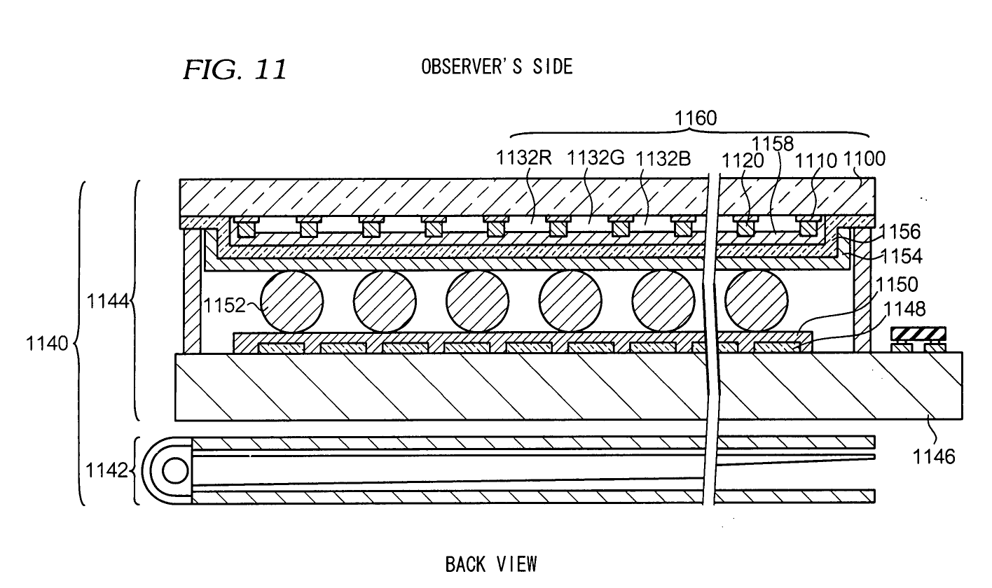

FIG. 11 is a sectional view of an electronic optical device having a color filter. As shown in the figure, electronic optical device 1140 comprises, to describe roughly, a back light system 1142 for emitting light to an observer's side, and a passive-type liquid crystal display panel 1144 for selectively transmitting light emitted from back light system 1142. Liquid crystal display panel 1144 comprises a substrate 1146, an electrode 1148, an orientation film 1150, a spacer 1152, an orientation film 1154, an electrode 1156, and a color filter 1160. Red color filter 1132R, green color filter 1132G, and blue color filter 1132B included in color filter 1160 are patterned by a droplet ejecting device of the present invention, and have approximately the same thickness as a designed value. Also, on the back of each color filter 1132R, 1132Q and 1132B, there is provided an overcoat layer 1158 that serves to protect each color filter.

A space between two orientation films 1150 and 1154 facing each other through spacers 1152 encloses liquid crystal. When a drive signal is supplied to electrodes 1148 and 1156, the liquid crystal selectively transmits light emitted from back light system 1142 for each region corresponding to each color filter 1132R, 1132G, and 1132B.

Next, FIG. 12 is an external view of a mobile phone 1200 having electronic optical device 1140 mounted thereto. In the figure, mobile phone 1200 comprises electronic optical device 1140 having a color filter as a display unit for displaying a variety of information such as telephone numbers, in addition to a plurality of operation buttons 1210, a receiver 1220, and a mouthpiece 1230.

In addition to mobile phone 1200, electronic optical device 1140 manufactured by means of a droplet ejecting device of the present invention may be used as a display unit for various electronic devices such as a computer, a projector, a digital camera, a movie camera, PDA (Personal Digital Assistant), vehicle-mounted equipment, a photocopier, or audio equipment.

What is claimed is:

1. A droplet ejecting device comprising:
liquid storing means for storing a liquid;
a droplet ejecting head for, by being applied an ejection waveform thereto, ejecting a liquid supplied from said liquid storing means in the form of a droplet;
measuring means for measuring a viscosity of a liquid stored in said liquid storing means;
determining means for determining whether the measured viscosity of a liquid is within a range of the liquid being ejectable;
memorizing means for memorizing an ejection waveform corresponding to a viscosity being set within said range of the liquid being ejectable; and
control means for, if a result of said determination is affirmative, applying an ejection waveform to ejection in said droplet ejecting head, said ejection waveform being one of ejection waveforms memorized in said memorizing means and corresponding to a viscosity measured by said measuring means.

2. A droplet ejecting device according to claim 1,
wherein said control means suspends ejection in said droplet ejecting head, if a result of the determination by said determining means is negative.

3. A droplet ejecting device according to claim 2, further comprising:
viscosity changing means for changing the viscosity of a liquid in said liquid storing means,
wherein said control means suspends the ejection of a liquid in said droplet ejecting head as well as changes, by said viscosity changing means, the viscosity of the liquid in said liquid storing means and causes the viscosity to come into said range of the liquid being ejectable, if a result of said determination is negative.

4. A droplet ejecting device according to claim 1,
wherein said measuring means comprises:
an electrode unit immersed in a liquid in said liquid storing means;
an oscillation circuit connected to said electrode;
an oscillation frequency measuring unit for measuring an oscillation frequency of said oscillation circuit at said electrode unit; and
a viscosity measuring unit for measuring a viscosity on the basis of the ratio between the measured oscillation frequency and a natural oscillation frequency of said electrode unit.

5. A droplet ejecting device according to claim 1,
wherein a use of the droplet ejecting device is to eject one of a print liquid for printing, a conductive liquid for forming a conductor pattern, a liquid crystal material or a liquid material for forming a color filter in a display device, a liquid of EL (electroluminescence) material for forming an EL layer, a resist liquid for forming a resist layer, a biochemical liquid containing biochemical material, and a liquid of light-transparent material for forming a micro lens array.

6. An electronic optical device manufactured by using a droplet ejecting device according to claim 1.

7. An electronic device having an electronic optical device mounted thereto, said electronic optical device manufactured by using a droplet ejecting device according to claim 1.

8. A manufacturing method for manufacturing an electronic optical device by using a droplet ejecting device according to claim 1.

9. A droplet ejecting device according to claim 4,
wherein a use of the droplet ejecting device is to eject one of a print liquid for printing, a conductive liquid for forming a conductor pattern, a liquid crystal material or a liquid material for forming a color filter in a display device, a liquid of EL (electroluminescence) material for forming an EL layer, a resist liquid for forming a resist layer, a biochemical liquid containing biochemical material, and a liquid of light-transparent material for forming a micro lens array.

10. An electronic optical device manufactured by using a droplet ejecting device according to claim 4.

11. An electronic device having an electronic optical device mounted thereto, said electronic optical device manufactured by using a droplet ejecting device according to claim 4.

12. A manufacturing method for manufacturing an electronic optical device by using a droplet ejecting device according to claim 4.

13. An electronic optical device manufactured by using a droplet ejecting device according to claim 5.

14. An electronic device having an electronic optical device mounted thereto, said electronic optical device manufactured by using a droplet ejecting device according to claim 5.

15. A manufacturing method for manufacturing an electronic optical device by using a droplet ejecting device according to claim 5.

16. A droplet ejecting device comprising:
liquid storing means for storing a liquid;
a droplet ejecting head for ejecting a liquid supplied from said liquid storing means in the form of a droplet;
measuring means for measuring a viscosity of a liquid stored in said liquid storing means;
determining means for determining whether the measured viscosity of a liquid is within a range of the liquid being ejectable;
viscosity changing means for changing a viscosity of a liquid in said liquid storing means; and
control means for, if a result of said determination is negative, suspending ejection in said droplet ejecting head as well as changing, by said viscosity changing means, the viscosity of the liquid in said liquid storing means and causing the viscosity to come into said range of the liquid being ejectable.

17. A droplet ejecting device according to claim 16,
wherein said measuring means comprises:
an electrode unit immersed in a liquid in said liquid storing means;
an oscillation circuit connected to said electrode;
an oscillation frequency measuring unit for measuring an oscillation frequency of said oscillation circuit at said electrode unit; and
a viscosity measuring unit for measuring a viscosity on the basis of the ratio between the measured oscillation frequency and a natural oscillation frequency of said electrode unit.

18. A droplet ejecting device according to claim 16,
wherein a use of the droplet ejecting device is to eject one of a print liquid for printing, a conductive liquid for forming a conductor pattern, a liquid crystal material or a liquid material for forming a color filter in a display device, a liquid of EL (electroluminescence) material for forming an EL layer, a resist liquid for forming a resist layer, a biochemical liquid containing biochemical material, and a liquid of light-transparent material for forming a micro lens array.

19. An electronic optical device manufactured by using a droplet ejecting device according to claim 16.

20. An electronic device having an electronic optical device mounted thereto, said electronic optical device manufactured by using a droplet ejecting device according to claim 16.

21. A manufacturing method for manufacturing an electronic optical device by using a droplet ejecting device according to claim 16.

22. An ejection control method for controlling a droplet ejecting device which ejects, by being applied an ejection waveform thereto, a liquid in the form of a droplet, said liquid being supplied from a liquid storing means for storing a liquid, comprising:
a first step of measuring a viscosity of a liquid in said liquid storing means;
a second step of determining whether the measured viscosity of the liquid is within a range of the liquid being ejectable; and
a step of applying to ejection an ejection waveform corresponding to a viscosity measured in said first step when a result of the determination in said second step is affirmative.

23. An ejection control method for controlling a droplet ejecting device according to claim 22, further comprising:
a third step of suspending ejection of a droplet when a result of the determination in said second step is negative.

24. An ejection control method for controlling a droplet ejecting device according to claim 23,
wherein said third step is for further changing a viscosity of the liquid in said liquid storing means and causing the viscosity to come into said range of the liquid being ejectable.

25. An ejection control method for controlling a droplet ejecting device which ejects a liquid in the form of a droplet, said liquid being supplied from a liquid storing means for storing a liquid, comprising:
a first step of measuring a viscosity of a liquid in said liquid storing means;
a second step of determining whether the measured viscosity is within a range of the liquid being ejectable; and
a step of suspending ejection of a droplet as well as changing the viscosity of the liquid in said liquid storing means and causing the viscosity to come into said range of the liquid being ejectable.
